(19) United States
(12) Patent Application Publication
(10) Pub. No.: US 2026/0236146 A1
(43) Pub. Date: Aug. 13, 2026

(54) MEDIA DATA PROCESSING METHOD, APPARATUS, DEVICE, MEDIUM, AND PRODUCT

(71) Applicant: Beijing Zitiao Network Technology Co., Ltd., Beijing (CN)

(72) Inventors: Jiaju XU, Beijing (CN); Yuxuan YE, Beijing (CN); Fengyi SHANG, Beijing (CN); Guojin HE, Beijing (CN)

(21) Appl. No.: 19/532,947

(22) Filed: Feb. 6, 2026

(30) Foreign Application Priority Data
Feb. 8, 2025 (CN) 202510142530.8

(51) Int. Cl. G06F 3/0484; G06F 3/0482; G11B 27/031

(52) U.S. Cl. CPC G06F 3/0484; G06F 3/0482; G11B 27/031

(57) ABSTRACT

Embodiments of the present disclosure provide a media data processing method, an apparatus, a device, a medium, and a product. The method comprises: displaying multiple preset media data editing modes in response to an editing trigger operation, where at least part of interface display information of interactive interfaces corresponding to different media data editing modes is different; and receiving a mode selection operation for a media data editing mode, and displaying an interactive interface based on the mode selection operation and the media data editing mode.

### CROSS-REFERENCE TO RELATED APPLICATIONS

This application claims priority to Chinese Application No. 202510142530.8 filed on Feb. 8, 2025, the disclosure of which is incorporated herein by reference in its entity.

### FIELD

Embodiments of the present disclosure relate to the field of computer processing technology, and in particular, to a media data processing method, an apparatus, a device, a medium, and a product.

### BACKGROUND

With the gradual development of terminal devices, more and more application software has gradually entered people's lives. Users may publish media content in video software or social software. In order to improve the display effect of the published media content, users may also edit media data to produce effect content and optimize the media content based on the effect content.

In the related art, there are many presentation styles of interactive interfaces for realizing media data editing, and switching between different interactive interfaces is required.

### SUMMARY

The present disclosure provides a media data processing method, an apparatus, a device, a medium, and a product.

In a first aspect, an embodiment of the present disclosure provides a media data processing method, including:

displaying a plurality of preset media data editing modes in response to an editing trigger operation, where at least part of interface display information of interactive interfaces corresponding to different media data editing modes is different; and

receiving a mode selection operation for a media data editing mode, and displaying an interactive interface based on the mode selection operation and the media data editing mode.

In a second aspect, an embodiment of the present disclosure further provides a media data processing apparatus, including:

an editing trigger module, configured to display a plurality of preset media data editing modes in response to an editing trigger operation, where at least part of interface display information of interactive interfaces corresponding to different media data editing modes is different; and

an interface display module, configured to receive a mode selection operation for the media data editing modes, and display an interactive interface based on the mode selection operation and the media data editing modes.

In a third aspect, an embodiment of the present disclosure further provides an electronic device, including:

one or more processors; and

a storage apparatus, configured to store one or more programs,

when the one or more programs are executed by the one or more processors, the one or more processors are caused to implement the media data processing method according to any one of the embodiments of the present disclosure.

In a fourth aspect, an embodiment of the present disclosure further provides a storage medium including computer-executable instructions, when the computer-executable instructions are executed by a computer processor, the media data processing method according to any one of the embodiments of the present disclosure is performed.

In a fifth aspect, an embodiment of the present disclosure further provides a computer program product, including a computer program, where when the computer program is executed by a processor, the media data processing method according to any one of the embodiments of the present disclosure is implemented.

### BRIEF DESCRIPTION OF THE DRAWINGS

The above and other features, advantages and aspects of the embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale.

FIG. 1 is a schematic flowchart of a media data processing method provided by an embodiment of the present disclosure;

FIG. 2 is a schematic interface diagram of an interactive interface suitable for a media data processing method provided by an embodiment of the present disclosure;

FIG. 3 is a schematic flowchart of another media data processing method provided by an embodiment of the present disclosure;

FIG. 4 is a schematic flowchart of another media data processing method provided by an embodiment of the present disclosure;

FIG. 5 is a schematic architectural diagram for generating an interactive interface suitable for a media data processing method provided by an embodiment of the present disclosure;

FIG. 6 is a schematic structural diagram of a media data processing apparatus provided by an embodiment of the present disclosure; and

FIG. 7 is a schematic structural diagram of an electronic device for implementing an embodiment of the present disclosure provided by an embodiment of the present disclosure.

### DETAILED DESCRIPTION OF EMBODIMENTS

Embodiments of the present disclosure will be described in more detail below with reference to the drawings. Although certain embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be performed in different orders and/or in parallel. In addition, the method implementations may include additional steps and/or omit the performing of the illustrated steps. The scope of the present disclosure is not limited in this regard.

As used herein, the term "include/comprise" and variations thereof are open-ended inclusions, that is, "include/comprise but not limited to". The term "based on" is "based at least in part on". The term "an embodiment" represents "at least one embodiment"; the term "another embodiment" represents "at least one other embodiment"; the term "some embodiments" represents "at least some embodiments". Relevant definitions of other terms will be given in the following description.

It should be noted that concepts such as "first" and "second" mentioned in the present disclosure are only used to distinguish different apparatuses, modules or units, and are not used to limit the order of functions performed by these apparatuses, modules or units, or interdependence therebetween.

It should be noted that the modifications of "a" and "a plurality of" mentioned in the present disclosure are exemplary rather than restrictive, and those skilled in the art should understand that they should be understood as "one or more", unless otherwise clearly indicated in the context.

The names of messages or information exchanged between a plurality of apparatuses in the implementations of the present disclosure are only for illustrative purposes, and are not intended to limit the scope of these messages or information.

It may be understood that before using the technical solutions disclosed in the embodiments of the present disclosure, the user should be informed of the type, range of use, use scenarios, etc. of personal information involved in the present disclosure in an appropriate manner and obtain the authorization of the user in accordance with relevant laws and regulations.

For example, in response to receiving an active request from a user, prompt information is sent to the user to clearly prompt the user that the requested operation will require access to and use of the user's personal information. In this way, the user may independently choose, according to the prompt information, whether to provide the personal information to software or hardware, such as an electronic device, an application, a server or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to choose whether to "agree" or "disagree" to provide the personal information to the electronic device.

It may be understood that the above process of notifying and obtaining user authorization is only exemplary, and does not constitute a limitation on the implementations of the present disclosure. Other methods that satisfy relevant laws and regulations may also be applied to the implementations of the present disclosure.

It may be understood that the data involved in the technical solution (including but not limited to the data itself, acquisition or use of the data) should comply with the requirements of corresponding laws, regulations and related provisions.

In some scenarios, the interactive interfaces before and after switching differ greatly in layout and operation mode, and it is difficult to match operation habits of different users. Moreover, switching between different interactive interfaces is often implemented based on preset interface switching logic, and users often have no way of knowing the interface switching logic. Therefore, users need to be familiar with and adapt to a variety of interactive interfaces in the process of editing media data, resulting in low efficiency of media data editing.

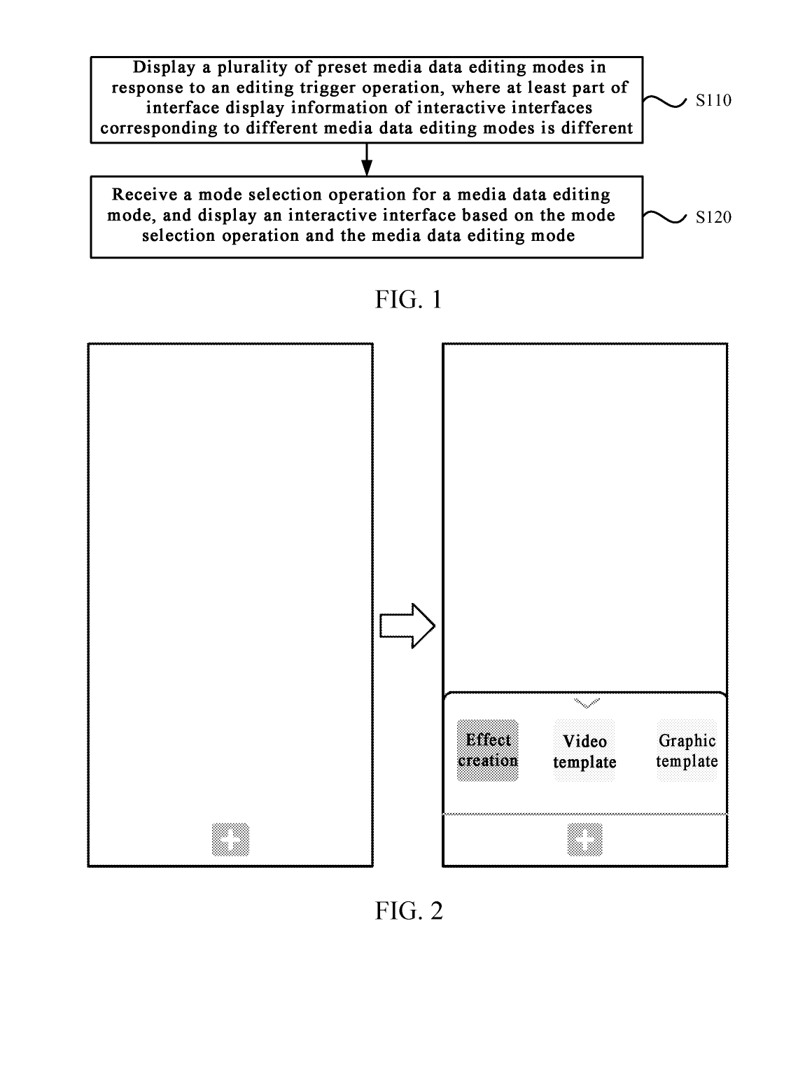

FIG. 1 is a schematic flowchart of a media data processing method provided by an embodiment of the present disclosure. The embodiment of the present disclosure is applicable to a scenario of processing media data. The method may be performed by a media data processing apparatus, which may be implemented in the form of software and/or hardware, optionally, by an electronic device, which may be a mobile terminal, a PC or a server, etc.

As shown in FIG. 1, the method of this embodiment may specifically include the following steps.

S110, a plurality of preset media data editing modes are displayed in response to an editing trigger operation, where at least part of interface display information of interactive interfaces corresponding to different media data editing modes is different.

Among them, the editing trigger operation may be understood as an operation used to trigger editing of media data. In the embodiment of the present disclosure, the editing trigger operation may be a control trigger operation performed on a preset editing control, such as a click operation, a slide operation, etc. The media data editing modes may be understood as preset modes for editing media data. The number of the preset media data editing modes may be one, two or more. In the embodiment of the present disclosure, different media data editing modes may have their own unique media data editing methods. Optionally, the media data editing modes may include an effect file editing mode and a template file editing mode. Among them, the effect file editing mode may be understood as a mode for editing an effect file to obtain the effect file; or a mode of processing media data with an effect element to cause the media data to present an expected effect. In short, the effect file editing mode is configured as a mode for producing an effect file that presents an expected effect or a mode of processing first media data into second media data that presents the expected effect. The template file editing mode may be understood as a mode for editing a template file. Optionally, the template file editing mode may include a video file editing mode and/or an image file editing mode. Among them, the video file editing mode may be understood as being used to edit a video file to obtain a video effect file. The image file editing mode may be understood as being used to edit an image file to obtain an image effect file.

In some embodiments, the effect file may be a file produced by an effect producing application, and the file may be used to perform effect processing on the media data. The effect file may also be a file obtained after processing the media data by applying a preset effect element or pre-edited effect processing logic, etc. The template file may be understood as a preset file for processing edited media data according to a preset processing method. Generally speaking, by adding first media data to the template file or replacing media data in the template file, second media data that presents a display effect corresponding to the template file may be obtained. Specifically, the template file may contain information such as predefined rules, layouts, styles, and formats, which is used to guide how to process and display the media data. The template data includes at least one data placeholder for indicating where to insert specific media data. Exemplarily, the template file may include at least one of data placeholders such as a text placeholder, a picture placeholder, a video clip placeholder, an audio placeholder, and a graphic and animation placeholder. The text placeholder is used to insert text content such as a title, a subtitle, and description text. The text placeholder usually has specific font, size and color settings to ensure that the text content can maintain a consistent style and format after insertion. The picture placeholder is used to insert visual elements such as a photo and an image. These placeholders usually have a fixed size and proportion to ensure that the inserted picture can perfectly fit into the layout and design of the video template.

The video clip placeholder is used to insert at least one of information such as a video clip or an animation effect. These placeholders may specify attributes such as a playing time, a position of the video clip and whether the video clip includes audio. By replacing these placeholders, users may easily add their own video content to the video template. The audio placeholder is used to insert at least one audio content such as background music, voice-over or sound effects. The audio placeholder may specify at least one of attributes such as audio playing time, volume and channel. By replacing the audio placeholder, users may add appropriate audio elements to the video template to enhance the appeal and attractiveness of the video. The graphic and animation placeholder is used to insert at least one of information such as graphic elements such as a shape, a line and an icon, and an animation effect. The graphic and animation placeholder may specify at least one of attributes such as a size, a color, a position and an animation effect of the graphic. By replacing these placeholders, users may add rich graphic and animation elements to the video template to enhance the visual effect and interest of the video. By using the template file, content with consistent format and style may be automatically generated. For example, in a news website, an article template may be used to automatically generate news reports with a unified layout and style. The template file makes content creation and editing easier and more efficient. Once a template is created, it may be reused to generate multiple documents or media with the same format but different content.

In the embodiment of the present disclosure, the media data editing mode may be associated with media data editing information. In short, media data editing information corresponding to different media data editing modes is at least partially different. In the embodiment of the present disclosure, the media data editing information may include at least one of information such as edited media data, optional editing elements, and an edited target file. The target file may include an effect file and/or a template file, etc. In the embodiment of the present disclosure, the edited media data may include media content of at least one multimedia selected from a group consisting of an image, text, a video, an audio, etc. In the embodiment of the present disclosure, the media content to be edited is used as a carrier of an effect application, and the visual effect of the media content is enhanced by adding effect elements, thereby realizing the editing of multimedia media data. In the embodiment of the present disclosure, the optional editing elements may be understood as selectable effect elements preset for the media data editing mode. Exemplarily, the media data editing information of the template file editing mode and the media data editing information of the effect file editing mode may be optional editing elements. Among them, the optional editing elements of the template file editing mode and the optional editing elements of the effect file editing mode may be partially different, or may be completely different. Exemplarily, the target file edited in the effect file editing mode is an effect file; the target file edited in the template file editing mode is a template file. Alternatively, the optional editing elements of the effect file editing mode include an effect element A, an effect element B and an effect element C; the optional editing elements of the template file editing mode include the effect element A, the effect element C and an effect element D. The edited target file may be understood as a file obtained after editing the media data.

Among them, the interactive interface may be understood as an interface for editing the media data. In the embodiment of the present disclosure, at least part of the interface display information of the interactive interfaces corresponding to different media data editing modes is different. In the embodiment of the present disclosure, by setting corresponding interactive interfaces for different media data editing modes, the convenience and operation efficiency of media data editing may be greatly improved. The characteristics and editing requirements of different media data editing modes are fully considered, so that each media data editing mode may be presented to the media data editor in a form of interface that is more suitable for its functions and characteristics. In the embodiment of the present disclosure, the interface display information may include interface layout information and/or interface display elements. Among them, the interface layout information may be used to set an organization and arrangement mode of the interface display elements on the interactive interface. Optionally, the interface layout information may include at least one of layout information such as interface menu position information, control position information, image position information, etc. The interface display elements may be understood as visual components in the interactive interface that are used to display information and guide user operations.

In the embodiment of the present disclosure, for the media data editing mode, the interface display elements that need to be displayed on the interactive interface corresponding to the media data editing mode are preset. Different media data editing modes correspond to interactive interfaces including different numbers of elements and/or different element objects of the interface display elements. Exemplarily, the media data editing modes include a media data editing mode A, a media data editing mode B and a media data editing mode C. The interactive interfaces include an interactive interface A, an interactive interface B and an interactive interface C. Among them, the media data editing mode A corresponds to the interactive interface A, the media data editing mode B corresponds to the interactive interface B, and the media data editing mode C corresponds to the interactive interface C. Among them, the interactive interface A includes an interface display element 1, an interface display element 2 and an interface display element 3. The interactive interface B includes the interface display element 1 and the interface display element 2. The interactive interface C includes an interface display element 3, an interface display element 4 and an interface display element 5.

In the embodiment of the present disclosure, after receiving the editing trigger operation, a visual interface including a plurality of preset media data editing modes may be determined according to the editing trigger operation. Then, the visual interface including the plurality of preset media data editing modes may be displayed to display the plurality of preset media data editing modes. Among them, a display style of the plurality of preset media data editing modes in the visual interface may be set according to actual needs, which is not specifically limited herein.

Exemplarily, as shown in FIG. 2, a target interface (interactive interface) is displayed, where the target interface includes a preset trigger control (see "+" in FIG. 2). After receiving a control trigger operation performed on the preset trigger control in the target interface, a visual interface including an effect creation editing mode, a video template editing mode and a graphic simulation editing mode may be displayed. In the embodiment of the present disclosure, an interface size of the visual interface and an interface size of the target interface may be the same or different.

S120, a mode selection operation for a media data editing mode is received, and an interactive interface is displayed based on the mode selection operation and the media data editing mode.

Among them, the mode selection operation may be understood as an operation used to select the media data editing mode. Optionally, the mode selection operation may be a trigger operation (such as a click operation) performed on the media data editing mode. In the embodiment of the present disclosure, the required media data editing mode may be flexibly selected from the plurality of preset media data editing modes through the mode selection operation, thereby reflecting the flexibility of media data editing. This flexibility not only meets diverse editing requirements for the media data, but also improves the level of personalization and customization of the media data editing process. On this basis, after the media data editing mode is selected through the media data editing selection operation, the media data may be edited through the interactive interface corresponding to the media data editing mode, thereby improving the efficiency of media data editing and the experience of media data editing.

Specifically, after receiving the mode selection operation performed on the media data editing modes, a selected media data editing mode may be determined based on the mode selection operation. Then, an interactive interface corresponding to the selected media data editing mode may be determined based on a correspondence between the media data editing modes and the interactive interfaces. After the interactive interface corresponding to the selected media data editing mode is determined, the interactive interface corresponding to the selected media data editing mode may be displayed.

In the embodiment of the present disclosure, before the plurality of preset media data editing modes are displayed, or after the mode selection operation for the media data editing mode is received, the method may further include: receiving a component configuration operation for the media data editing mode, and generating a mode editing container according to the component configuration operation, where the mode editing container is configured with a plurality of target components presented in the interactive interface corresponding to the media data editing mode.

Among them, the component configuration operation may be understood as an operation used to configure components that need to be presented in the interactive interface corresponding to the media data editing mode. The component configuration operation may include a component click operation and/or a component drag-and-drop operation. The mode editing container may be configured with a plurality of target components presented in the interactive interface corresponding to the media data editing mode. The target components may be understood as components that need to be presented in the interactive interface corresponding to the media data editing mode. In the embodiment of the present disclosure, there are multiple manners of receiving the component configuration operation for the media data editing mode and generating the mode editing container according to the component configuration operation.

As an optional implementation of the present disclosure, the component configuration operation may include the component click operation; and receiving the component configuration operation for the media data editing mode and generating the mode editing container according to the component configuration operation includes: displaying a component configuration interface, where the component configuration interface may include a plurality of candidate components. After receiving the component click operation performed on a candidate component, a selected component can be determined. Thus, the mode editing container can be obtained based on the selected component. In the embodiment of the present disclosure, the number of components selected in each component click operation may be one, two or more. In the embodiment of the present disclosure, after the selected component is determined, the method may further include: after receiving the component click operation performed on the selected component, deselecting the selected component.

As another optional implementation of the present disclosure, the component configuration operation may include the component drag-and-drop operation; and receiving the component configuration operation for the media data editing mode and generating the mode editing container according to the component configuration operation includes: displaying a component configuration interface, where the component configuration interface includes a first area and a second area, and the first area includes a plurality of candidate components. After receiving a component drag-and-drop operation of dragging a candidate component in the first area to the second area, generating the mode editing container based on components that have been dragged in the second area. In the embodiment of the present disclosure, the number of components dragged in each component drag-and-drop operation may be one. In the embodiment of the present disclosure, after the candidate component in the first area is dragged to the second area, the method may further include: after receiving a component drag-and-drop operation of dragging a component in the second area to the first area, updating the mode editing container generated based on the components in the second area.

As yet another optional implementation of the present disclosure, as another optional implementation of the present disclosure, the component configuration operation may include the component drag-and-drop operation and the component click operation; displaying a component configuration interface, where the component configuration interface includes a first area and a second area, and the first area includes a plurality of candidate components. A selected component may be determined in response to the component click operation performed on a candidate component in the first area, where the number of the selected component may be one, two or more. After receiving a component drag-and-drop operation of dragging the selected component from the first area to the second area, the mode editing container is generated based on components that have been dragged in the second area.

On the basis of the above embodiments, after one or more mode editing containers are generated, the components in the generated mode editing container(s) may also be modified. Specifically, the one or more mode editing containers are displayed. In response to a component deleting operation for a component in the mode editing container, the mode editing container is updated based on the component modifying operation. Specifically, after a container selection operation for the mode editing container is received, a selected mode editing container may be determined, and the component corresponding to the selected mode editing container is displayed; and after the component deleting operation for the component is received, the mode editing container is updated based on the component deleting operation.

In the technical solutions of the embodiments of the present disclosure, a plurality of preset media data editing modes are displayed in response to an editing trigger operation, which supports visual editing of media data. Since at least part of interface display information of interactive interfaces corresponding to different media data editing modes is different, the corresponding interactive interfaces are set for different media data editing modes, which may greatly improve the convenience and operation efficiency of media data editing. After that, a mode selection operation for the media data editing mode is received, and an interactive interface is displayed according to the mode selection operation and the media data editing mode, which supports flexible selection of the media data editing modes according to simple interactive operations, so as to easily edit the media data through the interactive interface, solves the technical problems of difficult operation and low editing efficiency when editing media data in the related art, and achieves the effects of improving the convenience, operation efficiency and flexibility of media data editing.

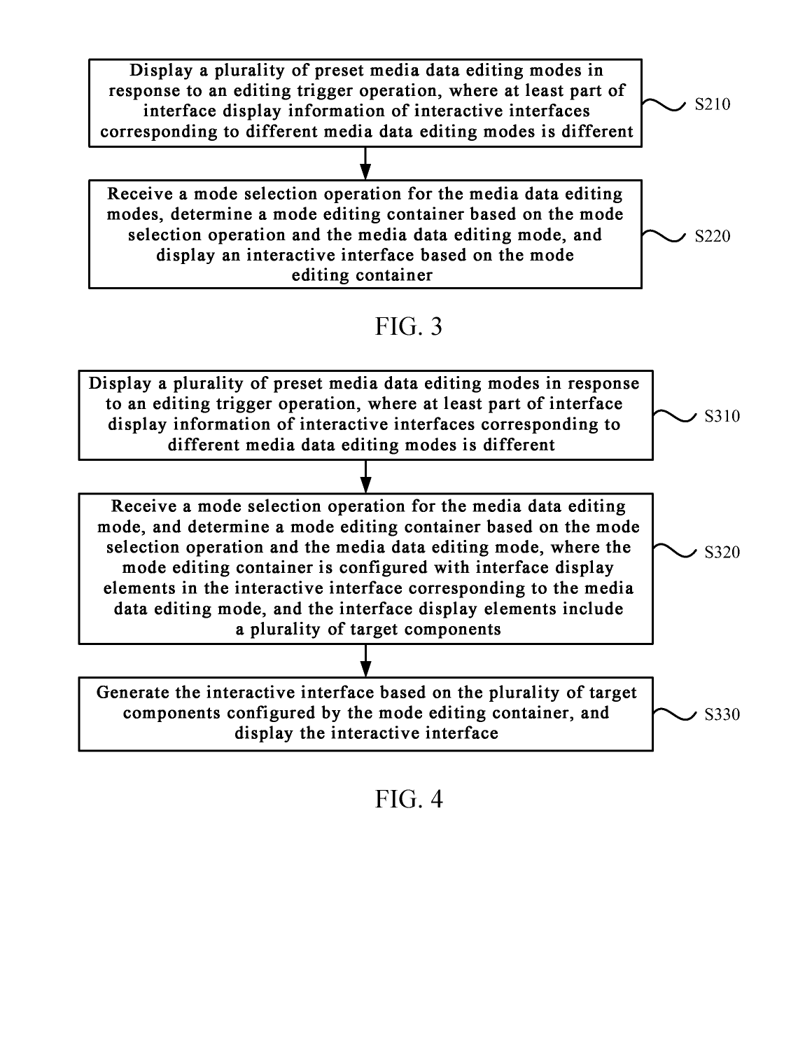

FIG. 3 is a schematic flowchart of another media data processing method according to an embodiment of the present disclosure. On the basis of the above embodiments, the technical solution of this embodiment further details the manner of displaying an interactive interface according to a mode selection operation and media data editing modes. Optionally, displaying the interactive interface according to the mode selection operation and the media data editing mode includes: determining a mode editing container according to the mode selection operation and the media data editing modes, and displaying the interactive interface according to the mode editing container; where the mode editing container is configured with interface display elements in the interactive interface corresponding to the media data editing mode. For the specific implementation, reference may be made to the description of this embodiment. The technical features the same as or similar to those of the previous embodiments are not repeated herein. As shown in FIG. 3, the method of this embodiment may specifically include the following steps.

S210, a plurality of preset media data editing modes are displayed in response to an editing trigger operation, where at least part of interface display information of interactive interfaces corresponding to different media data editing modes is different.

S220, a mode selection operation for the media data editing modes is received, a mode editing container is determined based on the mode selection operation and the media data editing mode, and an interactive interface is displayed based on the mode editing container.

Among them, the mode editing container may be used to configure interface display elements in the interactive interface corresponding to the media data editing mode. Different mode editing containers correspond to different interactive interfaces, and the interface display elements in different interactive interfaces are at least partially different. Exemplarily, the mode editing containers include a mode editing container A, a mode editing container B and a mode editing container C. The interactive interfaces include an interactive interface A, an interactive interface B and an interactive interface C. The mode editing container A corresponds to the interactive interface A, the mode editing container B corresponds to the interactive interface B, and the mode editing container C corresponds to the interactive interface C. The interactive interface A includes an interface display element 1, an interface display element 2 and an interface display element 3. The interactive interface B includes the interface display element 1, the interface display element 3 and an interface display element 4. The interactive interface A includes an interface display element 5, an interface display element 6 and an interface display element 7.

In the embodiment of the present disclosure, the mode editing container may dynamically adjust an interface layout and element display according to different media data editing modes, so that the interactive interface may quickly adapt to different requirements, thereby improving the flexibility and expandability of the interface. In addition, the use of the mode editing container may separate interface display elements and logic in different media data editing modes, thereby reducing the coupling between codes. This makes the code clearer, easier to understand and maintain, and helps reduce errors and debugging time. Further, since the layout and elements of the interactive interface may require different adjustments on different devices or platforms, cross-platform adaptation may be more easily realized by setting mode editing container, and it is ensured that the interactive interface may provide a consistent operation experience on different devices.

Specifically, after the mode selection operation for the media data editing mode is received, a selected media data editing mode may be determined. Then, a mode editing container corresponding to the selected media data editing mode may be determined based on a correspondence between the media data editing mode and the mode editing container. Then, an interactive interface corresponding to the mode editing container may be determined according to the mode editing container, that is, the interactive interface corresponding to the selected media data editing mode is determined. After the interactive interface corresponding to the selected media data editing mode is determined, the interactive interface corresponding to the selected media data editing mode may be displayed.

In the embodiment of the present disclosure, in the case where there are a plurality of mode editing containers, determining the mode editing container corresponding to the selected media data editing mode based on the correspondence between the media data editing mode and the mode editing container may include: presetting the correspondence between the media data editing mode and the mode editing container. Then, based on the correspondence between the media data editing mode and the mode editing container, matching out a mode editing container matching with the selected media data editing mode from the plurality of mode editing containers.

In the embodiment of the present disclosure, displaying the interactive interface according to the mode editing container includes: first determining the interface display elements in the mode editing container; generating the interactive interface based on the interface display elements. Then, the generated interactive interface is displayed. In the embodiment of the present disclosure, there are multiple manners of generating the interactive interface based on the interface elements.

As an optional implementation of the present disclosure, generating the interactive interface based on the interface elements includes: in the case where the interface elements are configured with element layout attributes, obtaining the interactive interface based on the element layout attributes configured by the interface elements. Among them, the element layout attributes may be used to determine a positioning and arrangement mode of each interface display element in the interactive interface. Optionally, the element layout attributes may include at least one of element positioning attributes, element display attributes, element size attributes, margins, paddings, floating, alignment, responsive layout, etc. The positioning attributes may include at least one of absolute positioning, relative positioning and static positioning. The display attributes may include at least one of a block-level element, an inline element, an inline block-level element, a flexible box layout, etc. The size attributes may be used to define a size of the interface display elements, and may include a width, a height, a maximum width, a maximum height, a minimum width and a minimum height.

As another optional implementation of the present disclosure, generating the interactive interface based on the interface elements includes: obtaining layout display information of the interface display elements; and generating the interactive interface based on the layout display information and the interface display elements. In the embodiment of the present disclosure, the layout display information may be used to determine how to organize and present each of the interface display elements of the interactive interface. Optionally, the layout display information may include a size (such as a width and a height), a position (such as a margin and an alignment mode), a spacing (such as a gap between elements), and a possible layout mode (such as a grid layout, a flexible box layout or a flow layout), etc.

In the technical solution of the embodiment of the present disclosure, a mode editing container is determined according to a mode selection operation and media data editing modes, and an interactive interface is displayed according to the mode editing container; where the mode editing container is configured with interface display elements in the interactive interface corresponding to the media data editing mode. In the technical solution of the embodiment of the present disclosure, the interface display elements in the interactive interface are configured through the mode editing container, thereby improving the flexibility and expandability of the interactive interface.

FIG. 4 is a schematic flowchart of another media data processing method according to an embodiment of the present disclosure. On the basis of the above embodiments, the technical solution of this embodiment further details the manner of displaying an interactive interface according to a mode editing container. Optionally, the interface display elements include a plurality of target components; and displaying the interactive interface according to the mode editing container includes: generating the interactive interface according to the plurality of target components configured by the mode editing container, and displaying the interactive interface. For the specific implementation, reference may be made to the description of this embodiment. The technical features the same as or similar to those of the previous embodiments are not repeated herein. As shown in FIG. 4, the method of this embodiment may specifically include the following steps.

S310, a plurality of preset media data editing modes are displayed in response to an editing trigger operation, where at least part of interface display information of interactive interfaces corresponding to different media data editing modes is different.

S320, a mode selection operation for a media data editing mode is received, and a mode editing container is determined based on the mode selection operation and the media data editing mode, where the mode editing container is configured with interface display elements in the interactive interface corresponding to the media data editing modes, and the interface display elements include a plurality of target components.

S330, the interactive interface is generated according to the plurality of target components configured by the mode editing container, and displaying the interactive interface.

Specifically, for the plurality of target components configured by the mode editing container, interface layout information of each of the target components may be determined separately. Then, the interactive interface may be generated according to the target components and the interface layout information thereof, and the interactive interface is displayed. The interface layout information may be used to determine a positioning and arrangement mode of each target component in the interactive interface. Optionally, the interface layout information may include a component size (such as a width and a height), a component position (such as a margin and an alignment mode), a component spacing (such as a gap between elements), etc.

In the embodiment of the present disclosure, generating the interactive interface according to the plurality of target components configured by the mode editing container includes: determining target interfaces corresponding to each of the target components separately from an interface layer, and invoking target program data corresponding to the target components in a program data layer through the target interfaces to obtain the interactive interface.

Among them, a plurality of preset interfaces may be pre-packaged in the interface layer to invoke corresponding preset program data in the program data layer. The program data layer may include a plurality of pieces of preset program data to support the generation of an interactive interface based on a target component. In the embodiment of the present disclosure, the code of the interactive interface is clearly divided into the interface layer and the program data layer, the input and output are processed through the interface layer, and the data processing and logic implementation are performed through the program data layer, which may significantly improve the maintainability, expandability, modularity, security, and the convenience of testing and debugging of the interactive interface. This hierarchical architecture provides a basis for building an efficient, flexible and secure media data editing process. It should be noted that the correspondence between the components and the interfaces may be one-to-one or many-to-one. In short, at least one component uses one interface. That is, multiple components may share one interface.

In the embodiment of the present disclosure, the program data in the program data layer includes customized program data and program data provided by a software development kit. In practical applications, the program data layer generally includes multiple pieces of program data. In the embodiment of the present disclosure, the correspondence between the program data in the program data layer and the interfaces in the interface layer may be one-to-one or many-to-one. That is, multiple pieces of program data in the program data may be packaged to correspond to one interface in the interface layer, and a manner in which one interface is implemented by multiple pieces of program data may be realized, so that the program data meets the requirement of high cohesion in code development. In addition, in the embodiment of the present disclosure, the coupling between codes is separated through the interface layer and the program data layer, so that the program development meets the requirement of low coupling.

For the plurality of target components configured by the mode editing container, a preset interface corresponding to each of the target components may be determined from the preset interfaces in the interface layer, that is, a target interface corresponding to each of the target components is obtained. After that, based on the correspondence between the interfaces and the preset program data in the program data layer, the target program data corresponding to the target components in the program data layer may be determined. Thus, the target program data corresponding to the target components in the program data layer may be invoked through the target interface to obtain the interactive interface. Invoking the target program data corresponding to the target components in the program data layer through the target interface to obtain the interactive interface may specifically be: for each target component, interface layout information of the target component may be passed, as an actual parameter, to a formal parameter of the target program data corresponding to the target component through the target interface. After the parameter passing is completed, the target program data may be executed to obtain a program processing result of the target program data based on the interface layout information of the target component, that is, the interactive interface. Then, the interactive interface may be output through the target interface, that is, the interactive interface is displayed.

In the embodiment of the present disclosure, the target component may include a first component and a second component. The second component may be used to edit a presentation effect of the media data. The first component may be used to configure interface presentation information of the second component. A plurality of first components are stored in a first component layer, and a plurality of second components are stored in a second component layer. The second component may be understood as a component provided by the second component layer and used to interact with the media data. Optionally, the second component may include components such as a text component and/or a filter component. The first component may be understood as a component provided by the first component layer and used to configure the interface presentation information of the second component. The first component may include at least one of a menu component, a title component, a playing component, etc. In the embodiment of the present disclosure, the component is divided into the first component and the second component, and they are stored in different levels respectively, which realizes the modularization and decoupling of the code, and helps to reduce the complexity of the system and improve the development efficiency. Further, the hierarchical and componentized design may make the interactive interface easier to customize and expand. For example, a new first component may be easily added to configure new interface presentation information, or a new second component may be added to support a new presentation effect of the media data.

On the basis of the above embodiments, generating the interactive interface according to the plurality of target components configured by the mode editing container may include: generating an initial editing interface according to the plurality of first components configured by the mode editing container, and generating the interactive interface according to the second components and the initial editing interface. The initial editing interface may be understood as a visual interface generated according to the plurality of first components configured by the mode editing container.

Specifically, the plurality of first components configured by the mode editing container may be obtained from the first component layer first. Then, the initial editing interface may be generated according to the plurality of first components configured by the mode editing container. After that, the plurality of second components configured by the mode editing container may be obtained from the second component layer. Further, the interactive interface may be generated according to the second components and the initial editing interface.

In the embodiment of the present disclosure, generating the initial editing interface according to the plurality of first components configured by the mode editing container includes: for each of the first components configured by the mode editing container, obtaining component layout information of the first component; and generating the initial editing interface according to the component layout information of each of the first components and the plurality of first components in the mode editing container. Specifically, a blank visual interface may be built first; and then, each of the first components is added to the blank visual interface according to the component layout information of each of the first components, so that a visual interface added with the first components may be obtained, that is, the initial editing interface is obtained.

In the embodiment of the present disclosure, generating the interactive interface according to the second components and the initial editing interface includes: for each of the second components configured by the mode editing container, obtaining component layout information of the second component; and generating the interactive interface according to the component layout information of each of the second components and the plurality of second components in the mode editing container. Specifically, each of the second components is added to the initial editing interface according to the component layout information of each of the second components, so that a visual interface added with the second components may be obtained, that is, the interactive interface is obtained.

In the technical solution of the embodiment of the present disclosure, the interface display elements include a plurality of target components. The interactive interface may be generated according to the plurality of target components configured by the mode editing container and displayed. In the technical solution of the embodiment of the present disclosure, the function of generating the interactive interface according to the plurality of target components configured by the mode editing container is realized.

As an optional embodiment of the present disclosure, an embodiment of the present disclosure provides a schematic architectural diagram of an architecture for producing an interactive interface. Referring to FIG. 5, in the embodiment of the present disclosure, the architecture for generating the interactive interface may include, from bottom to top, a program data layer, an interface layer, a second component layer, a first component layer and an editing container layer. On the basis of this architecture, the step of displaying the interactive interface corresponding to the media data editing mode includes the following steps.

Step 1. After an editing trigger operation is received, a plurality of preset media data editing modes may be displayed; and after mode selection operation for the media data editing mode is received, a target mode editing container corresponding to a media data editing mode may be determined from a plurality of preset mode editing containers in the editing container layer. In the embodiment of the present disclosure, the mode editing container is configured with a plurality of target components in the interactive interface corresponding to the media data editing mode. The target components include a first component and a second component. The target components include the first component and the second component, the second component is used to edit a presentation effect of the media data, and the first component is used to configure interface presentation information of the second component; a plurality of first components are stored in the first component layer, and a plurality of second components are stored in the second component layer.

Exemplarily, the preset mode editing containers in the editing container layer include a mode editing container A, a mode editing container B and a mode editing container C. The mode editing container A corresponds to the media data editing mode A, the mode editing container B corresponds to the media data editing mode B, and the mode editing container C corresponds to the media data editing mode C. In the case where the media data editing mode selected by the editing trigger operation is the media data editing mode B, it may be determined that the mode editing container B corresponding to the media data editing mode B is configured with a plurality of target components in the interactive interface corresponding to the media data editing mode B. The target components include a menu component located in the first component layer and a text component located in the second component layer.

Step 2. The plurality of first components configured by the mode editing container may be obtained from the first component layer first; interfaces corresponding to each of the first components are determined from the interface layer, respectively; and the first program data corresponding to each of the first components in the program data layer is invoked through the interfaces corresponding to each of the first components to obtain the initial editing interface. After that, the plurality of second components configured by the mode editing container may be obtained from the second component layer; interfaces corresponding to each of the second components are determined from the interface layer; and the second program data corresponding to each of the second components in the program data layer is invoked through the interfaces corresponding to each of the second components, and the second components are added to the initial editing interface to obtain the interactive interface.

Continuing with the above example, the menu component is obtained from the first component layer, and component style information of a title component is determined. Then, the interface corresponding to the menu component, that is, an interface A, may be determined from the interface layer, respectively. Then, the component style information of the menu component may be passed, through the interface A, to the program data A corresponding to the menu component in the program data layer. Then, by executing the program data A, the menu component may be added to a blank visual interface to obtain the initial editing interface. After that, the interface corresponding to the text component, that is, an interface B, is determined from the interface layer. Then, the component style information of the text component may be passed, through the interface B, to the program data C corresponding to the text component in the program data layer. Then, by executing the program data C, the text component may be added to the initial editing interface to generate the interactive interface, and the interactive interface is sent to the interface display interface corresponding to the display of the interactive interface in the interface layer. Thus, the interactive interface may be displayed through the interface display interface.

In the technical solution of the embodiment of the present disclosure, the interactive interface is obtained by providing the architecture for generating the interactive interface, which improves the convenience, operation efficiency and flexibility of media data editing.

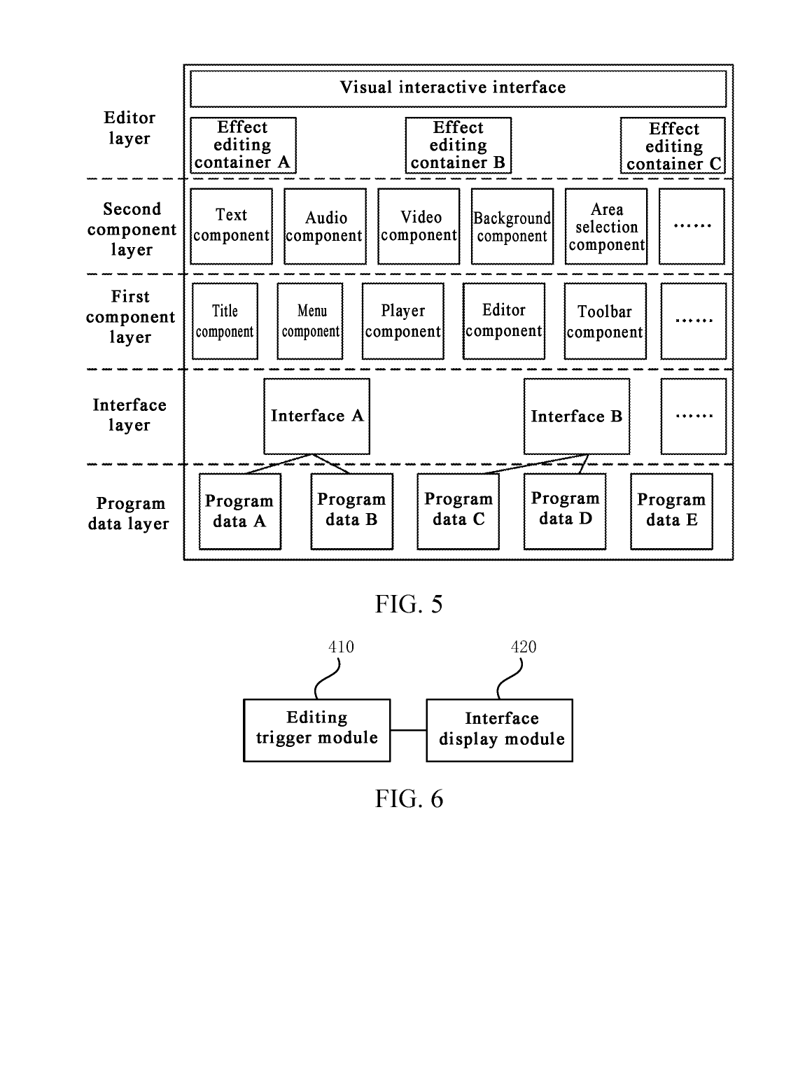

FIG. 6 is a schematic structural diagram of a media data processing apparatus provided by an embodiment of the present disclosure. As shown in FIG. 6, the apparatus includes an editing trigger module 410 and an interface display module 420.

Among them, the editing trigger module 410 is configured to display a plurality of preset media data editing modes in response to an editing trigger operation, where at least part of interface display information of interactive interfaces corresponding to different media data editing modes is different; and the interface display module 420 is configured to receive a mode selection operation for a media data editing mode, and display an interactive interface according to the mode selection operation and the media data editing mode.

In the technical solutions of the embodiments of the present disclosure, a plurality of preset media data editing modes are displayed by the editing trigger module 410 in response to an editing trigger operation, which supports visual editing of media data. Since at least part of interface display information of interactive interfaces corresponding to different media data editing modes is different, the corresponding interactive interfaces are set for different media data editing modes, which may greatly improve the convenience and operation efficiency of media data editing. After that, a mode selection operation for the media data editing modes is received by the interface display module 420, and an interactive interface is displayed according to the mode selection operation and the media data editing mode, which supports flexible selection of the media data editing modes according to simple interactive operations, so as to easily edit the media data through the interactive interface, solves the technical problems of difficult operation and low editing efficiency when editing media data in the related art, and achieves the effects of improving the convenience, operation efficiency and flexibility of media data editing.

On the basis of any optional technical solution in the embodiments of the present disclosure, optionally, the interface display module 420 is configured to determine a mode editing container according to the mode selection operation and the media data editing mode, and display the interactive interface according to the mode editing container; where the mode editing container is configured with interface display elements in the interactive interface corresponding to the media data editing mode.

On the basis of any optional technical solution in the embodiments of the present disclosure, optionally, the interface display elements include a plurality of target components; and the interface display module 420 is configured to generate the interactive interface according to the plurality of target components configured by the mode editing container, and display the interactive interface.

On the basis of any optional technical solution in the embodiments of the present disclosure, optionally, the target component includes a first component and a second component, the second component is used to edit a presentation effect of the media data, and the first component is used to configure interface presentation information of the second component; a plurality of first components are stored in the first component layer, and a plurality of second components are stored in the second component layer.

On the basis of any optional technical solution in the embodiments of the present disclosure, optionally, the interface display module 420 is configured to generate an initial editing interface according to the plurality of first components configured by the mode editing container, and generate the interactive interface according to the second components and the initial editing interface.

On the basis of any optional technical solution in the embodiments of the present disclosure, optionally, the interface display module 420 is configured to determine, from an interface layer, target interfaces corresponding to each of the target components, respectively, and invoke, through the target interfaces, target program data corresponding to the target components in a program data layer to obtain the interactive interface.

On the basis of any optional technical solution in the embodiments of the present disclosure, optionally, the media data processing apparatus further includes a mode editing container configuration module, configured to, before the plurality of preset media data editing modes are displayed, or after the mode selection operation for the media data editing modes is received, receive a component configuration operation for the media data editing modes, and generate a mode editing container according to the component configuration operation, where the mode editing container is configured with a plurality of target components presented in the interactive interface corresponding to the media data editing mode.

On the basis of any optional technical solution in the embodiments of the present disclosure, optionally, the media data editing modes are associated with media data editing information; the media data editing information includes at least one of edited media data, optional editing elements, and a target file obtained through editing; and the target file includes an effect file and/or a template file.

The media data processing apparatus provided by the embodiment of the present disclosure may perform the media data processing method provided by any embodiment of the present disclosure, and has corresponding functional modules and beneficial effects for performing the media data processing method.

It is worth noting that the units and modules included in the above apparatus are only divided according to functional logic, but are not limited to the above division, as long as the corresponding functions may be realized. In addition, the specific names of the functional units are only for the convenience of distinguishing from each other, and are not used to limit the protection scope of the embodiments of the present disclosure.

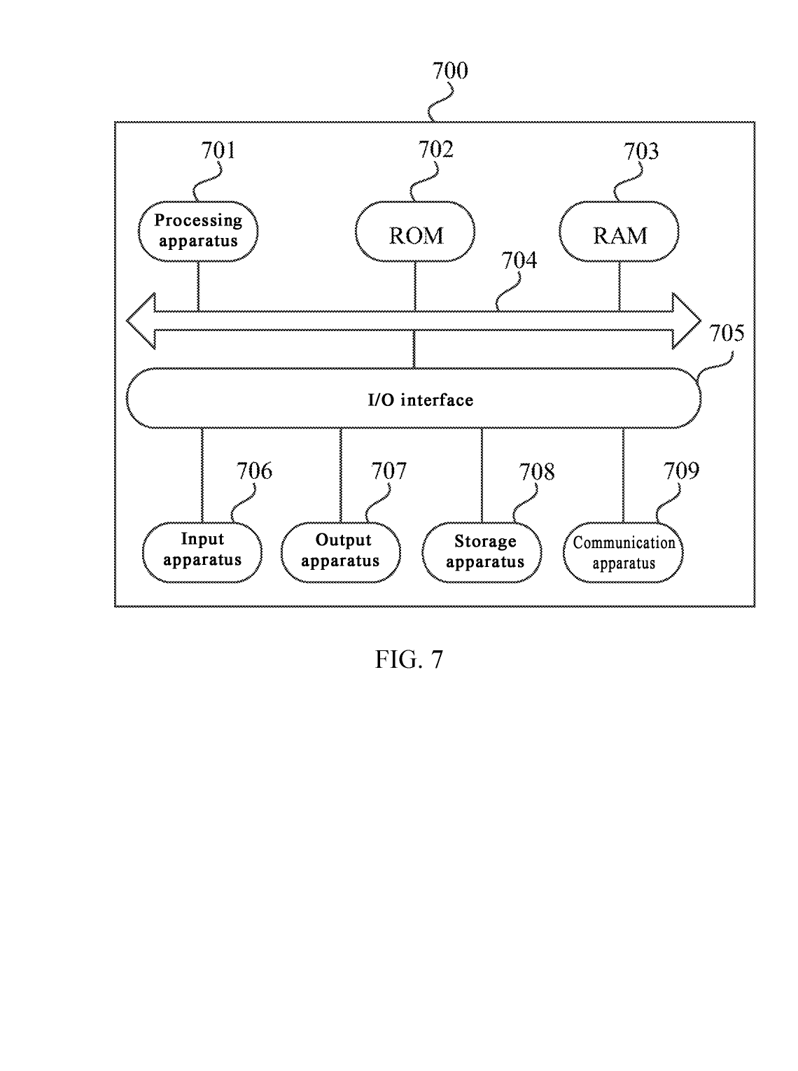

Reference is made to FIG. 7 below, which illustrates a schematic structural diagram of an electronic device (such as a terminal device or a server) 700 suitable for implementing an embodiment of the present disclosure. The terminal device in the embodiment of the present disclosure may include, but are not limited to, mobile terminals such as a mobile phone, a laptop, a digital broadcast receiver, a PDA (personal digital assistant), a PAD (tablet computer), a PMP (portable multimedia player), a vehicle-mounted terminal (such as a vehicle navigation terminal), etc., and stationary terminals such as a digital TV, a desktop computer, etc. The electronic device shown in FIG. 7 is only an example, and should not impose any limitation on the function and scope of use of the embodiments of the present disclosure.

As shown in FIG. 7, the electronic device 700 may include a processing apparatus (such as a central processing unit, a graphics processing unit, etc.) 701, which may perform various appropriate actions and processing according to a program stored in a read-only memory (ROM) 702 or a program loaded from a storage apparatus 708 into a random-access memory (RAM) 703. The RAM 703 further stores various programs and data required for the operation of the electronic device 700. The processing apparatus 701, the ROM 702 and the RAM 703 are connected to each other through a bus 704. An input/output (I/O) interface 705 is also connected to the bus 704.

Usually, the following apparatuses may be connected to the I/O interface 705: an input apparatus 706 including, for example, a touch screen, a touchpad, a keyboard, a mouse, a camera, a microphone, an accelerometer, a gyroscope, etc.; an output apparatus 707 including, for example, a liquid crystal display (LCD), a speaker, a vibrator, etc.; a storage apparatus 708 including, for example, a magnetic tape, a hard disk, etc.; and a communication apparatus 709. The communication apparatus 709 may allow the electronic device 700 to perform wireless or wired communication with other devices to exchange data. Although FIG. 7 shows the electronic device 700 having various apparatuses, it should be understood that not all the apparatuses shown herein need to be implemented or provided. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program code for performing the method shown in the flowchart. In such an embodiment, the computer program may be downloaded and installed from a network through the communication apparatus 709, or installed from the storage apparatus 708, or installed from the ROM 702. When the computer program is executed by the processing apparatus 701, the above-mentioned functions defined in the method of the embodiments of the present disclosure are executed.

The names of messages or information exchanged between a plurality of apparatuses in the implementations of the present disclosure are only for illustrative purposes, and are not intended to limit the scope of these messages or information.

The electronic device provided by the embodiment of the present disclosure belongs to the same inventive concept as the media data processing method provided by the above-mentioned embodiments. For technical details not described in detail in the embodiments of the present disclosure, reference may be made to the above-mentioned embodiments, and this embodiment has the same beneficial effects as the above-mentioned embodiments.

An embodiment of the present disclosure provides a computer storage medium having a computer program stored thereon, where when the program is executed by a processor, the media data processing method provided by the above-mentioned embodiments is implemented.

It should be noted that the above-mentioned computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, apparatus or device, or any suitable combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus or device. In the present disclosure, the computer-readable signal medium may include a data signal propagated on a baseband or as a part of a carrier wave, and computer-readable program code is carried therein. This propagated data signal may take a variety of forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program used by or in combination with the instruction execution system, apparatus or device. The program code contained on the computer-readable medium may be transmitted by any suitable medium, including but not limited to: a wire, an optical cable, an RF (radio frequency), etc., or any suitable combination of the above.

According to one or more embodiments of the present disclosure, [Example 1] provides a media data processing method, including:

displaying a plurality of preset media data editing modes in response to an editing trigger operation, where at least part of interface display information of interactive interfaces corresponding to different media data editing modes is different; and receiving a mode selection operation for a media data editing mode, and displaying an interactive interface based on the mode selection operation and the media data editing mode.

According to one or more embodiments of the present disclosure, [Example 2] provides the method of Example 1, further including: optionally,

displaying the interactive interface based on the mode selection operation and the media data editing modes including: determining a mode editing container based on the mode selection operation and the media data editing mode, and displaying the interactive interface based on the mode editing container; where the mode editing container is configured with interface display elements in the interactive interface corresponding to the media data editing mode.

According to one or more embodiments of the present disclosure, [Example 3] provides the method of Example 1, further including: optionally,

the interface display elements including a plurality of target components; and displaying the interactive interface based on the mode editing container including: generating the interactive interface based on the plurality of target components configured by the mode editing container, and displaying the interactive interface.

According to one or more embodiments of the present disclosure, [Example 4] provides the method of Example 1, further including: optionally,

the target component including a first component and a second component, the second component being used to edit a presentation effect of the media data, and the first component being used to configure interface presentation information of the second component; a plurality of first components being stored in the first component layer, and a plurality of second components being stored in the second component layer.

According to one or more embodiments of the present disclosure, [Example 5] provides the method of Example 1, further including: optionally,

generating the interactive interface based on the plurality of target components configured by the mode editing container including: generating an initial editing interface based on the plurality of first components configured by the mode editing container, and generating the interactive interface based on the second components and the initial editing interface.

According to one or more embodiments of the present disclosure, [Example 6] provides the method of Example 1, further including: optionally,

generating the interactive interface based on the plurality of target components configured by the mode editing container includes: determining, from an interface layer, target interfaces corresponding to each of the target components, and invoking, through the target interfaces, target program data corresponding to the target components in a program data layer to obtain the interactive interface.

According to one or more embodiments of the present disclosure, [Example 7] provides the method of Example 1, further including: optionally,

before the plurality of preset media data editing modes are displayed, or after the mode selection operation for the media data editing modes is received, the method further including: receiving a component configuration operation for the media data editing mode, and generating a mode editing container based on the component configuration operation, where the mode editing container is configured with a plurality of target components presented in the interactive interface corresponding to the media data editing mode.

According to one or more embodiments of the present disclosure, [Example 8] provides the method of Example 1, further including: optionally,

the media data editing modes being associated with media data editing information; the media data editing information including at least one of edited media data, optional editing elements, and a target file obtained through editing; and the target file including an effect file and/or a template file.

According to one or more embodiments of the present disclosure, [Example 9] provides a media data processing apparatus, including:

an editing trigger module, configured to display a plurality of preset media data editing modes in response to an editing trigger operation, where at least part of interface display information of interactive interfaces corresponding to different media data editing modes is different; and an interface display module, configured to receive a mode selection operation for a media data editing mode, and display an interactive interface based on the mode selection operation and the media data editing mode.

In some implementations, a client and a server may communicate using any currently known or future developed network protocol, such as the HTTP (HyperText Transfer Protocol), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The above-mentioned computer-readable medium may be included in the above-mentioned electronic device, or it may exist alone without being assembled into the electronic device.

The above-mentioned computer-readable medium carries one or more programs, and when the one or more programs are executed by the electronic device, the electronic device is caused to display a plurality of preset media data editing modes in response to an editing trigger operation, where at least part of interface display information of interactive interfaces corresponding to different media data editing modes is different; and receive a mode selection operation for the media data editing modes, and display an interactive interface according to the mode selection operation and the media data editing modes.

The computer program code for performing the operations of the present disclosure may be written in one or more programming languages or a combination thereof, where the one or more programming languages include but are not limited to object-oriented programming languages such as Java, Smalltalk, C++, and include conventional procedural programming languages such as "C" language or similar programming languages. The program code may be executed entirely on a user's computer, partly on the user's computer, as a stand-alone software package, partly on the user's computer and partly on a remote computer, or entirely on the remote computer or a server. In the case of involving the remote computer, the remote computer may be connected to the user's computer through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the systems, methods and computer program products according to various embodiments of the present disclosure. In this regard, each block in the flowchart or block diagrams may represent a module, a program segment, or a part of code that includes one or more executable instructions for implementing the specified logical functions. It should also be noted that, in some alternative implementations, the functions noted in the block may occur in an order different from that noted in the drawings. For example, two blocks shown in succession may, in fact, be executed substantially concurrently, or the blocks may sometimes be executed in the reverse order, depending upon the functionality involved. It also should be noted that each block of the block diagrams and/or flowcharts, or a combination of blocks in the block diagrams and/or flowcharts may be implemented in a special purpose hardware-based system that perform a specified function or operation, or may be implemented in a combination of special purpose hardware and a computer instruction.

The involved units described in the embodiments of the present disclosure may be implemented by means of software, and may also be implemented by means of hardware. The name of a unit does not constitute a limitation on the unit itself under certain circumstances, for example, the interface display module may also be described as "a module for displaying an interactive interface according to a mode selection operation and media data editing modes".

The functions described above herein may be performed at least in part by one or more hardware logic components. For example, without limitation, exemplary types of hardware logic components that may be used include: a field Programmable Gate Array (FPGA), an Application Specific Integrated Circuit (ASIC), an Application Specific Standard Product (ASSP), a System on Chip (SOC), a Complex Programmable Logical Device (CPLD) and more.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium includes, but is not limited to, an electronic, magnetic, optical, electromagnetic, infrared, or semi-conductive system, apparatus or device, or any suitable combination of the above. More specific examples of the machine-readable storage medium would include an electrical connection based on one or more wires, a portable computer magnetic disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the above.

The above description is only a preferred embodiment of the present disclosure and an explanation of the applied technical principles. Those skilled in the art should understand that the disclosed scope involved in the present disclosure is not limited to the technical solutions formed by the specific combinations of the above technical features, and should also cover other technical solutions formed by any combination of the above technical features or their equivalent features without departing from the above disclosed concept. For example, a technical solution formed by replacing the above features with technical features with similar functions disclosed in (but not limited to) the present disclosure.

Additionally, although operations are depicted in a particular order, it should not be understood that these operations are required to be performed in a specific order as illustrated or in a sequential order. Under certain circumstances, multitasking and parallel processing may be advantageous. Likewise, although several specific implementation details are included in the above discussion, these should not be interpreted as limiting the scope of the present disclosure. Certain features that are described in the context of separate embodiments may also be implemented in combination in a single embodiment. Conversely, various features that are described in the context of a single embodiment may also be implemented in a plurality of embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely exemplary forms for implementing the claims.

We claim:

1. A media data processing method, comprising:
displaying a plurality of preset media data editing modes in response to an editing trigger operation, wherein at least part of interface display information of interactive interfaces corresponding to different media data editing modes is different; and
receiving a mode selection operation for a media data editing mode, and displaying an interactive interface based on the mode selection operation and the media data editing mode.

2. The media data processing method of claim 1, wherein displaying the interactive interface based on the mode selection operation and the media data editing mode comprises:
determining a mode editing container based on the mode selection operation and the media data editing mode, and displaying the interactive interface based on the mode editing container, wherein the mode editing container is configured with an interface display element in the interactive interface corresponding to the media data editing mode.

3. The media data processing method of claim 2, wherein the interface display element comprises a plurality of components, and displaying the interactive interface based on the mode editing container comprises:
generating the interactive interface based on the plurality of components configured for the mode editing container, and displaying the interactive interface.

4. The media data processing method of claim 3, wherein the component comprises a first component and a second component, the second component is configured to edit a presentation effect of the media data, and the first component is configured to configure interface presentation information of the second component, a plurality of first components are stored in a first component layer, and a plurality of second components are stored in a second component layer.

5. The media data processing method of claim 4, wherein generating the interactive interface based on the plurality of components configured for the mode editing container comprises:
generating an initial editing interface based on the plurality of first components configured for the mode editing container, and generating the interactive interface based on the second components and the initial editing interface.

6. The media data processing method of claim 3, wherein generating the interactive interface based on the plurality of components configured for the mode editing container comprises:
obtaining the interactive interface by determining, from an interface layer, a interface corresponding to each of the components, and invoking, through the interface, program data corresponding to the components in a program data layer.

7. The media data processing method of claim 1, wherein before displaying the plurality of preset media data editing modes, or after receiving the mode selection operation for the media data editing mode, the method further comprises:
receiving a component configuration operation for the media data editing mode, and generating a mode editing container based on the component configuration operation, wherein the mode editing container is configured with a plurality of components presented in the interactive interface corresponding to the media data editing mode.

8. The media data processing method of claim 1, wherein the media data editing mode is associated with media data editing information, the media data editing information comprises at least one of edited media data, optional editing elements, and a file obtained through editing, and the file comprises an effect file and/or a template file.

9. An electronic device, wherein the electronic device comprises:
one or more processors; and
a storage apparatus, configured to store one or more programs,
wherein the one or more programs, when executed by the one or more processors, cause the one or more processors to:
display a plurality of preset media data editing modes in response to an editing trigger operation, wherein at least part of interface display information of interactive interfaces corresponding to different media data editing modes is different; and
receive a mode selection operation for a media data editing mode, and display an interactive interface based on the mode selection operation and the media data editing mode.

10. The electronic device of claim 9, wherein the one or more programs causing the one or more processors to display the interactive interface based on the mode selection operation and the media data editing mode comprise instructions to:
determine a mode editing container based on the mode selection operation and the media data editing mode, and display the interactive interface based on the mode editing container, wherein the mode editing container is configured with an interface display element in the interactive interface corresponding to the media data editing mode.

11. The electronic device of claim 10, wherein the interface display element comprises a plurality of components and the one or more programs causing the one or more processors to display the interactive interface based on the mode editing container comprise instructions to:
generate the interactive interface based on the plurality of components configured for the mode editing container, and display the interactive interface.

12. The electronic device of claim 11, wherein the component comprises a first component and a second component, the second component is configured to edit a presentation effect of the media data, and the first component is configured to configure interface presentation information of the second component, a plurality of first components are stored in a first component layer, and a plurality of second components are stored in a second component layer.

13. The electronic device of claim 12, wherein the one or more programs causing the one or more processors to generate the interactive interface based on the plurality of components configured for the mode editing container comprise instructions to:
generate an initial editing interface based on the plurality of first components configured for the mode editing container, and generate the interactive interface based on the second components and the initial editing interface.

14. The electronic device of claim 11, wherein the one or more programs causing the one or more processors to generate the interactive interface based on the plurality of components configured for the mode editing container comprise instructions to:
obtain the interactive interface by determining, from an interface layer, a interface corresponding to each of the components, and invoke, through the interface, program data corresponding to the components in a program data layer.

15. The electronic device of claim 9, wherein before displaying the plurality of preset media data editing modes, or after receiving the mode selection operation for the media data editing mode, the one or more programs further comprise instructions to:
receive a component configuration operation for the media data editing mode, and generate a mode editing container based on the component configuration operation, wherein the mode editing container is configured with a plurality of components presented in the interactive interface corresponding to the media data editing mode.

16. The electronic device of claim 9, wherein the media data editing mode is associated with media data editing information, the media data editing information comprises at least one of edited media data, optional editing elements, and a file obtained through editing, and the file comprises an effect file and/or a template file.

17. A non-transitory storage medium comprising computer-executable instructions, wherein the computer-executable instructions, when executed by a computer processor, are configured to:
display a plurality of preset media data editing modes in response to an editing trigger operation, wherein at least part of interface display information of interactive interfaces corresponding to different media data editing modes is different; and
receive a mode selection operation for a media data editing mode, and display an interactive interface based on the mode selection operation and the media data editing mode.

18. The storage medium of claim 17, wherein the computer-executable instructions configured to display the interactive interface based on the mode selection operation and the media data editing mode comprise instructions to:
determine a mode editing container based on the mode selection operation and the media data editing mode, and display the interactive interface based on the mode editing container, wherein the mode editing container is configured with an interface display element in the interactive interface corresponding to the media data editing mode.

19. The storage medium of claim 18, wherein the interface display element comprises a plurality of components and the computer-executable instructions configured to display the interactive interface based on the mode editing container comprise instructions comprise instructions to:
generate the interactive interface based on the plurality of components configured for the mode editing container, and display the interactive interface.

20. The storage medium of claim 19, wherein the component comprises a first component and a second component, the second component is configured to edit a presentation effect of the media data, and the first component is configured to configure interface presentation information of the second component, a plurality of first components are stored in a first component layer, and a plurality of second components are stored in a second component layer.
